(19) United States
(12) Patent Application Publication
(10) Pub. No.: US 2015/0377205 A1
(43) Pub. Date: Dec. 31, 2015

(54) INTERNAL COMBUSTION ENGINE AND VEHICLE

(71) Applicant: GM GLOBAL TECHNOLOGY OPERATIONS LLC, Detroit, MI (US)

(72) Inventors: Cherian A. Idicheria, Novi, MI (US); Ronald O. Grover, JR., Northville, MI (US); Gerald A. Silvas, Columbus, MI (US); Edward R. Masters, Brighton, MI (US)

(21) Appl. No.: 14/317,025

(22) Filed: Jun. 27, 2014

(51) Int. Cl. F02P 15/00; F02F 1/24

(52) U.S. Cl. CPC F02P 15/001; F02F 1/24

(57) ABSTRACT

An internal combustion engine includes a cylinder block defining a combustion chamber therein, and a cylinder head mated to the cylinder block such that the cylinder head covers the combustion chamber. The internal combustion engine also includes a fuel nozzle configured for injecting a fuel into the combustion chamber and a plasma igniter configured for ejecting a plasma into the combustion chamber to ignite the fuel. The plasma igniter extends through the cylinder head and protrudes into the combustion chamber. The internal combustion engine further includes a dielectric coating disposed on the cylinder head. A vehicle including the internal combustion engine is also disclosed.

### TECHNICAL FIELD

The disclosure relates to an internal combustion engine for a vehicle.

### BACKGROUND

Vehicles may be powered by an internal combustion engine. During operation of the internal combustion engine, a heat source may ignite a fuel within a combustion chamber to combust the fuel and provide power to the vehicle. Such ignition may occur hundreds of times per second during specific operating modes of the internal combustion engine.

### SUMMARY

An internal combustion engine for a vehicle includes a cylinder block defining a combustion chamber therein. The internal combustion engine further includes a cylinder head mated to the cylinder block such that the cylinder head covers the combustion chamber. In addition, the internal combustion engine includes a fuel nozzle configured for injecting a fuel into the combustion chamber, and a plasma igniter configured for ejecting a plasma into the combustion chamber to ignite the fuel. The plasma igniter extends through the cylinder head and protrudes into the combustion chamber. Further, the internal combustion engine includes a dielectric coating disposed on the cylinder head.

In one embodiment, the internal combustion engine also includes a piston head disposed within the combustion chamber and alternatingly translatable towards and away from the cylinder head, wherein the dielectric coating is disposed on the cylinder head and the piston head.

A vehicle includes a plurality of wheels each rotatable to translate the vehicle along a surface, and an internal combustion engine operably connected to the plurality of wheels. The internal combustion engine includes a cylinder block defining a combustion chamber therein, and a cylinder head mated to the cylinder block such that the cylinder head covers the combustion chamber. The internal combustion engine also includes a fuel nozzle configured for injecting a fuel into the combustion chamber, and a plasma igniter configured for ejecting a plasma into the combustion chamber to ignite the fuel. The plasma igniter extends through the cylinder head and protrudes into the combustion chamber. The internal combustion engine also includes a dielectric coating disposed on the cylinder head.

As used herein, the terms “a,” “an,” “the,” “at least one,” and “one or more” are interchangeable and indicate that at least one of an item is present. A plurality of such items may be present unless the context clearly indicates otherwise. All numerical values of parameters, quantities, or conditions in this disclosure, including the appended claims, are to be understood as being modified in all instances by the term “about” or “approximately” whether or not “about” or “approximately” actually appears before the numerical value. “About” and “approximately” indicate that the stated numerical value allows some slight imprecision (e.g., with some approach to exactness in the value; reasonably close to the value; nearly; essentially). If the imprecision provided by “about” or “approximately” is not otherwise understood with this meaning, then “about” and “approximately” as used herein indicate at least variations that may arise from methods of measuring and using such parameters. Further, the terminology “substantially” also refers to a slight imprecision of a condition (e.g., with some approach to exactness of the condition; approximately or reasonably close to the condition; nearly; essentially). In addition, disclosed numerical ranges include disclosure of all values and further divided ranges within the entire range. Each value within a range and the endpoints of a range are all disclosed as separate embodiments. The terms “comprising,” “comprises,” “includes,” “including,” “has,” and “having” are inclusive and therefore specify the presence of stated items, but do not preclude the presence of other items. As used in this disclosure, the term “or” includes any and all combinations of one or more of the listed items.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a plan view of a vehicle, wherein the vehicle includes an internal combustion engine;

FIG. 2 is a schematic illustration of a cross-sectional fragmentary view of the internal combustion engine of FIG. 1, wherein the internal combustion engine defines a plurality of combustion chambers;

FIG. 3A is a schematic illustration of a cross-sectional view of one of the plurality of combustion chambers of FIG. 2, wherein a plasma igniter extends into the combustion chamber at a distance;

FIG. 3B is a schematic illustration of a cross-sectional view of the combustion chamber of FIG. 3A, wherein the plasma igniter extends into the combustion chamber at another distance;

FIG. 4 is a schematic illustration of a bottom view of the plasma igniter of FIG. 3A and a plasma ejected therefrom as viewed from position IV within the combustion chamber;

FIG. 5 is a schematic illustration of a bottom view of the plasma igniter of FIG. 3A and an electrical arc ejected therefrom as viewed from position IV within a comparative combustion chamber; and

FIG. 6 is a schematic illustration of a cross-sectional view of the combustion chamber of FIG. 3A taken along section lines 6-6.

### DETAILED DESCRIPTION

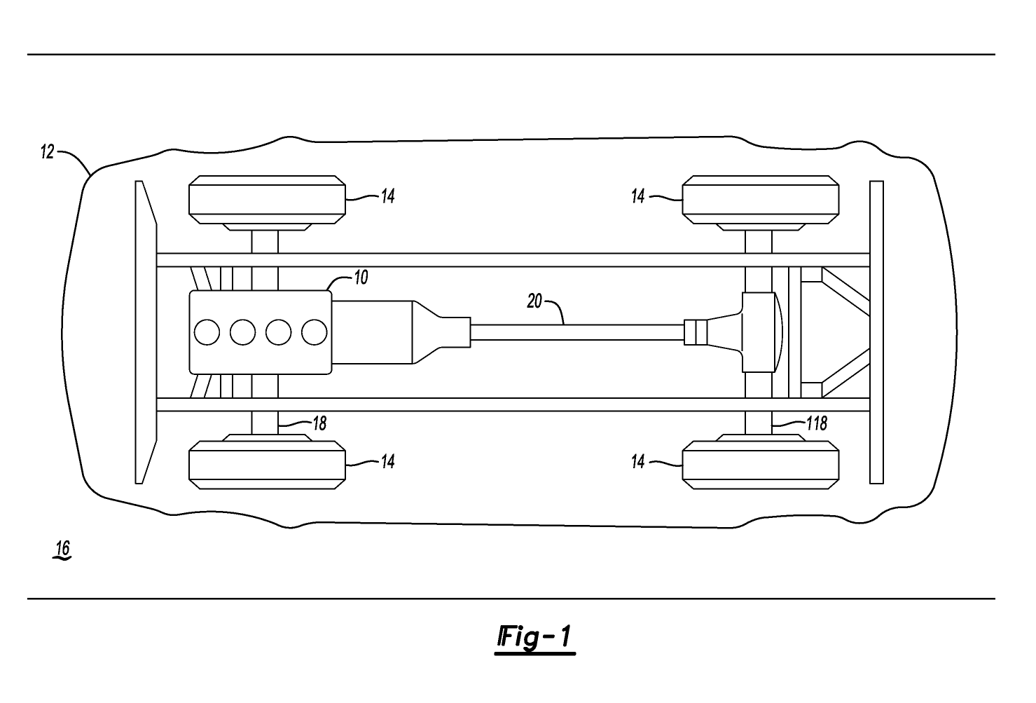

Referring to the Figures, wherein like reference numerals refer to like elements, an internal combustion engine 10 for a vehicle 12 is shown generally in FIG. 1. The internal combustion engine 10 and vehicle 12 may be useful for automotive applications, such as passenger sedans, sport utility vehicles, or trucks. However, the vehicle 12 and internal combustion engine 10 may also be useful for non-automotive applications, such as for industrial vehicles, recreational vehicles, or power generation.

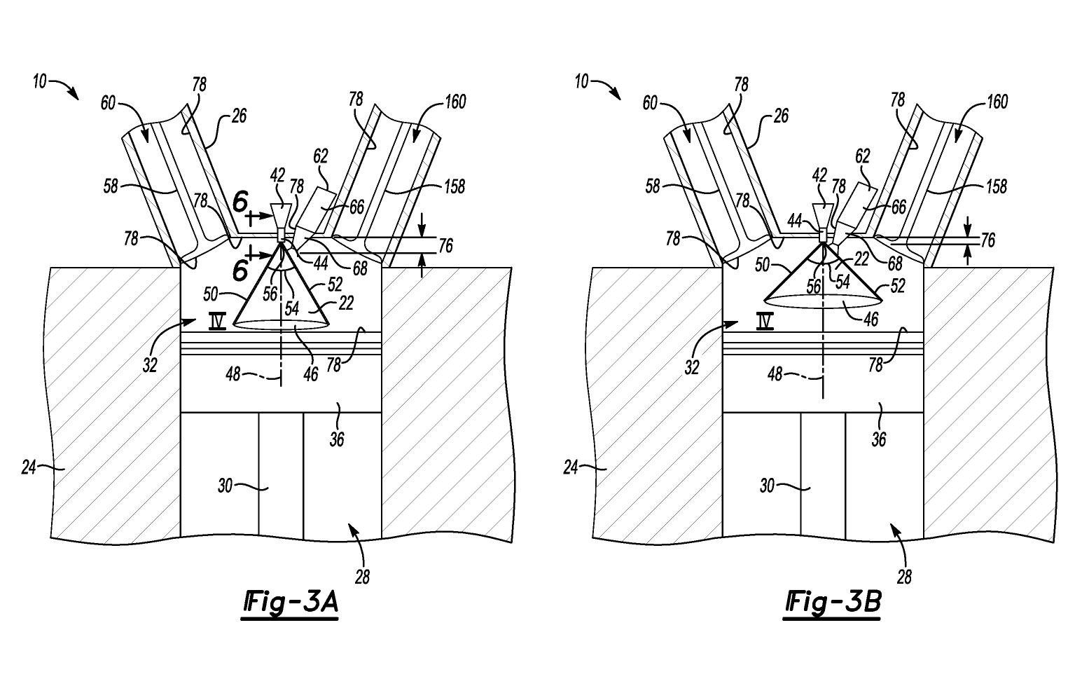

As described with reference to FIG. 1, the vehicle 12 includes a plurality of wheels 14, e.g., four wheels 14, each rotatable to translate the vehicle 12 along a surface 16. For example, a first two of four wheels 14 may be rotatable about a first axle 18 and a second two of four wheels 14 may be rotatable about a second axle 118 spaced apart from the first axle 18. The internal combustion engine 10 is operably connected to the plurality of wheels 14 to provide power for translating the vehicle 12 along the surface 16. For example, the internal combustion engine 10 may be connected to a crankshaft 20 and transmission (not shown) which may in turn rotate the first and/or second axles 18, 118. The internal combustion engine 10 may provide direct motive power to the plurality of wheels 14, such as via the crankshaft 20 connected to the plurality of axles 18, 118, or may provide power to one or more electric motors (not shown) and/or batteries (not shown), which may in turn provide direct motive power to the plurality of wheels 14. Regardless, the internal combustion engine 10 may be configured for providing power to the vehicle 12 by combusting a fuel 22 (FIGS. 3A and 3B) and converting chemical energy to mechanical energy.

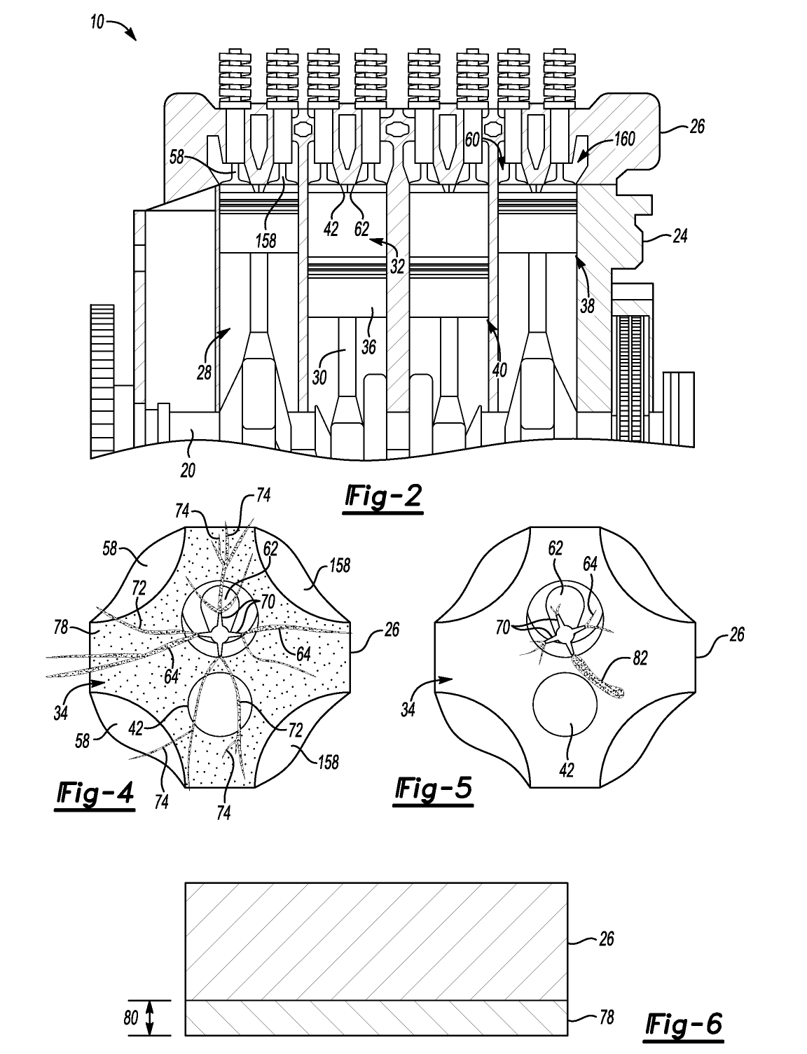

Referring now to FIG. 2, the internal combustion engine 10 includes a cylinder block 24 and a cylinder head 26 mated to the cylinder block 24. For example, the internal combustion engine 10 may include a head gasket (not shown) configured to sealingly mate the cylinder head 26 to the cylinder block 24. The cylinder block 24 defines a cylinder bore 28 therein configured for housing a piston 30. For example, the cylinder block 24 may define four, six, eight, or twelve cylinder bores 28 therein, and the internal combustion engine 10 may therefore be respectively characterized as a 4-cylinder, 6-cylinder, 8-cylinder, or 12-cylinder internal combustion engine 10. Alternatively, the cylinder block 24 may define one, two, three, or five cylinder bores 28 therein, and the internal combustion engine 10 may therefore be respectively characterized as a 1-cylinder, 2-cylinder, 3-cylinder, or 5-cylinder internal combustion engine 10.

In addition, as best shown in FIGS. 3A and 3B, the cylinder block 24 defines a combustion chamber 32 therein disposed between the piston 30 and the cylinder head 26. That is, the cylinder head 26 is mated to the cylinder block 24 such that the cylinder head 26 covers the combustion chamber 32. As such, the cylinder head 26 may include a portion 34 (FIG. 4) facing the combustion chamber 32.

Generally, as shown in FIG. 2, the internal combustion engine 10 may include the same number of pistons 30 as cylinder bores 28 so that one piston 30 is disposed within each cylinder bore 28 and is attached to the crankshaft 20. Each piston 30 may include a piston head 36 that is sized to slideably translate within the cylinder bore 28. Therefore, the piston head 36 may alternatingly translate towards and away from the cylinder head 26 to thereby move the crankshaft 20 so that the internal combustion engine 10 may convert linear motion of the piston 30 into rotational motion.

Referring again to FIG. 2, each of the plurality of pistons 30 is configured for reciprocating within a respective one of the cylinder bores 28 between a first position (shown generally at 38) and a second position (shown generally at 40) to thereby collectively intake and displace a quantity of air from the internal combustion engine 10. For example, the first position 38 may be characterized as “top dead center” and may refer to a position at which the piston head 36 is disposed farthest away from the crankshaft 20. Similarly, the second position 40 may be characterized as “bottom dead center” and may refer to a position at which the piston head 36 is disposed closest to the crankshaft 20. Therefore, as the plurality of pistons 30 reciprocate within the plurality of cylinder bores 28 between the first position 38 and the second position 40, the internal combustion engine 10 may “breathe” to intake and displace the quantity of air.

As best shown in FIGS. 3A and 3B, the internal combustion engine 10 also includes a fuel nozzle 42 configured for injecting the fuel 22 (shown schematically as a cone as one non-limiting example) into the combustion chamber 32. The fuel 22 may be, as non-limiting examples, gasoline, ethanol, diesel, natural gas, and combinations thereof. The fuel nozzle 42 may have an end valve 44 configured for ejecting the fuel 22 and may extend through the cylinder head 26 into the combustion chamber 32. The end valve 44 may define a plurality of holes (not shown) through which the fuel 22 may be ejected. A portion of the fuel 22 ejected through one of the plurality of holes may be referenced as a fuel plume. Therefore, the fuel 22 injected into the combustion chamber 32 by the fuel nozzle 42 may include one or more fuel plumes. Generally, the fuel nozzle 42 may be arranged to deliver the fuel 22 having a precise shape and including a precise quantity of fuel according to desired combustion characteristics and power requirements of the internal combustion engine 10. By way of non-limiting examples, the fuel 22 may have a generally conical shape, a generally triangular shape, a generally cylindrical shape, a generally oblong shape, a generally oval shape, or a generally amorphous or irregular shape.

For example, as described with reference to FIGS. 3A and 3B, the fuel 22 may have a first boundary 50 and a second boundary 52 defining a spray angle 54 therebetween. In one specific non-limiting example, the fuel 22 may have a generally conical shape and may include a base plane 46, e.g., a generally circular base plane, a central longitudinal axis 48 extending from and disposed perpendicular to the base plane 46, the first boundary 50 intersecting the base plane 46, and the second boundary 52 intersecting the base plane 46. Therefore, the first boundary 50 and the second boundary 52 may define the spray angle 54 therebetween and may intersect at a vertex 56 spaced apart from the base plane 46 along the central longitudinal axis 48. That is, the vertex 56 may be aligned with the end valve 44 of the fuel nozzle 42.

Referring again to FIGS. 3A and 3B, to optimize combustion of the fuel 22 within the combustion chamber 32, the internal combustion engine 10 may also include a valve 58, 158. In one embodiment, the cylinder head 26 defines a port 60, 160 therein, and the internal combustion engine 10 further includes the valve 58, 158 configured for alternatingly allowing and preventing fluid communication between the port 60, 160 and the combustion chamber 32. For example, the port 60 may be configured as an intake channel arranged to feed intake air into the combustion chamber 32 during operation of the internal combustion engine 10. Alternatively, the port 160 may be configured as an exhaust channel arranged to transmit exhaust gases from the combustion chamber 32 during operation of the internal combustion engine 10.

The valve 58, 158 may therefore be characterized as an intake valve 58 or an exhaust valve 158. In particular, the intake valve 58 may be arranged to selectively open and close to allow air and/or exhaust gases into each combustion chamber 32 before combustion. Similarly, the exhaust valve 158 may arranged to selectively open and close to exhaust combustion products from each combustion chamber 32 after combustion. As best shown in FIG. 3A, the internal combustion engine 10 may include two intake valves 58 and two exhaust valves 158 per each combustion chamber 32. In other non-limiting embodiments, the internal combustion engine 10 may include one or three intake valves 58 and one or three exhaust valves 158 per each combustion chamber 32.

The internal combustion engine 10 may operate under several combustion conditions. For example, the internal combustion engine 10 may operate under a stoichiometric combustion condition in which air and the fuel 22 are combined in a stoichiometric ratio within the combustion chamber 32. Alternatively, the internal combustion engine 10 may operate under a lean combustion condition in which air and the fuel 22 are not combined in a stoichiometric ratio within the combustion chamber 32. Lean combustion conditions include conditions in which the fuel 22 is diluted with air and/or exhaust gases within the combustion chamber 32 and may be characterized as lean-stratified combustion, homogeneous charge compression ignition (HCCI) combustion, spark-assisted compression ignition, or lean homogeneous combustion. In one embodiment, the internal combustion engine 10 may operate as a downsize boosted dilute combustion engine in which the internal combustion engine 10 includes a reduced number of cylinder bores 28 and combustion chambers 32 and includes a boosting device such as a turbocharger or supercharger.

Referring again to FIGS. 3A and 3B, the internal combustion engine 10 also includes a plasma igniter 62 configured for ejecting a plasma 64 (FIG. 4) into the combustion chamber 32 to ignite the fuel 22. As used herein, the terminology “plasma igniter 62” is contrasted with the terminology “spark plug” (not shown). A spark plug is configured for ejecting an electrical current characterized by a peak current of less than or equal to about 200 milliamps. In contrast, the plasma igniter 62 is configured for ejecting the plasma 64 characterized by a peak current that exceeds about 20 amperes. The plasma igniter 62 may be characterized as a corona discharge plasma igniter and may be selected according to desired combustion characteristics within the combustion chamber 32. Further, although not shown, the plasma igniter 62 may include a high-voltage transformer having a primary side and a secondary side. As a non-limiting example, at about 5 ms after firing, the primary side of the plasma igniter 62 may have a voltage of from about 45 V to about 55 V, an electrical current of from about 1 A to about 2.5 A, and a power of from about 90 W to about 110 W. As a non-limiting example, the secondary side of the plasma igniter 62 may have a voltage of from about 30 kV to about 60 kV, and an electrical current of from about 20 mA to about 200 mA.

As best shown in FIGS. 3A and 3B, the plasma igniter 62 extends through the cylinder head 26 and protrudes into the combustion chamber 32. For example, the plasma igniter 62 may be a two-piece assembly and may include an inductor 66 and a firing tip 68 operatively connected to the inductor 66. As best shown in FIG. 4, the firing tip 68 may include from two to six individual electrodes 70, e.g., four individual electrodes 70, each spaced apart from one another and arranged in a star configuration. When fired, the plasma igniter 62 may emit an electrical field of from about 10 kV to about 75 kV from the firing tip 68 into the combustion chamber 32. Without intending to be limited by theory, within several nanoseconds, the electrical field may excite the air and the fuel 22 within the combustion chamber 32 near the firing tip 68 and the individual electrodes 70 until the electrical field transitions to the plasma 64, which includes a plurality of charged ions.

As described with reference to FIG. 4, as a density of the plurality of charged ions reaches a threshold, the plasma 64 may include a plurality of streamers 72 each extending from the firing tip 68 and the plurality of electrodes 70. Each of the plurality of streamers 72 may be spaced apart from one another yet joined at a common center, e.g., the vertex 56. Each streamer 72 may also include one or more branches 74 emanating from the streamer 72. That is, as used herein, the terminology “streamer” refers to a portion of the plasma 64 having an elongated, flowing, ribbon-like appearance or characteristic. In other words, the plurality of streamers 72 may refer to a plurality of rays emanating or spreading out from a center of the plasma 64, and each streamer 72 may include one or more branches 74 which then further project or fork from the streamer 72. Each streamer 72 and/or branch 74 may be configured for igniting the fuel 22 within the combustion chamber 32. Therefore, the plurality of streamers 72 may ignite several portions of the fuel 22 at the same time and may provide fast, homogeneous, and effective combustion of the fuel 22.

Referring again to FIGS. 3A and 3B and as set forth above, the firing tip 68 may extend into the combustion chamber 32 at a desired protrusion or depth. For example, the firing tip 68 may be spaced apart from the cylinder head 26 by a distance 76 of from about 1 mm to about 15 mm, e.g., about 3 mm or about 5 mm or about 7 mm or about 9 mm or about 11 mm or about 13 mm. The distance 76 may be selected according to desired combustion characteristics within the combustion chamber 32, such as temperature, duration of combustion, and/or fuel spray angle 54. For example, generally, the firing tip 68 may extend farther into the combustion chamber 32, i.e., the distance 76 may be comparatively larger, for comparatively smaller fuel spray angles 54. Referring to FIG. 3A, in one non-limiting example, the firing tip 68 protrudes into the combustion chamber 32 at the distance 76 of from about 5 mm to about 15 mm, e.g., about 7 mm, and the spray angle 54 is from about 50° to about 70°, e.g., about 60°. Referring to FIG. 3B, in another non-limiting example, the firing tip 68 protrudes into the combustion chamber 32 at the distance 76 of from about 1 mm to about 5 mm, e.g., about 3 mm, and the spray angle 54 is from about 70° to about 120°, e.g., about 90 °.

Referring now to FIGS. 4 and 6, the internal combustion engine 10 also includes a dielectric coating 78 disposed on the cylinder head 26. That is, the cylinder head 26 may be coated with the dielectric coating 78. In one embodiment, the dielectric coating 78 may coat an entirety of the cylinder head 26. In another embodiment, the dielectric coating 78 may coat the portion 34 of the cylinder head 26 facing the combustion chamber 32. Alternatively or additionally, the dielectric coating 78 may coat the cylinder head 26 within the port 60, 160. That is, the dielectric coating 78 may be disposed on the cylinder head 26 within the port 60, 160. The dielectric coating 78 may have a thickness 80 (FIG. 6) of from about 0.05 mm to about 5 mm, e.g., from about 0.1 mm to about 4 mm or from about 1 mm to about 3 mm. The dielectric coating 78 may be applied to the cylinder head 26, e.g., by spraying, dip-coating, ion-beam sputtering, and/or electron beam deposition operations, before final assembly of the internal combustion engine 10.

The dielectric coating 78 may be selected to be heat-resistant, i.e., thermally stable at operating temperatures of the internal combustion engine 10. More specifically, the dielectric coating 78 may be heat-resistant at a temperature of less than or equal to about 1,100° C. That is, the dielectric coating 78 may not degrade or delaminate at a temperature of less than or equal to about 1,100° C. Further, the dielectric coating 78 may have excellent insulative properties, and may have a dielectric constant of from about 2 to about 5 and a dielectric breakdown strength of from about 290 V/μm to about 310 V/μm, e.g., about 300 V/μm, wherein 1 μm is equal to 1×10⁻⁶ m. The dielectric coating 78 may also exhibit excellent adhesion to the cylinder head 26 and may not delaminate during operation of the internal combustion engine 10.

The dielectric coating 78 may be a ceramic. By way of non-limiting examples, the dielectric coating 78 may be a metal oxide, such as an alumina; a fluoride; a polymer; and combinations thereof. For example, suitable dielectric coatings 78 may include silicon dioxide, aluminum oxide, titanium dioxide, yttrium oxide, tantalum pentoxide, magnesium fluoride, lanthanum fluoride, aluminum fluoride, and combinations thereof. A non-limiting example of a dielectric coating 78 is commercially available under the trade name Cerablak™ HTP from Applied Thin Films, Inc. of Skokie, Ill.

The dielectric coating 78 may insulate the cylinder head 26 and prevent the cylinder head 26 from acting as an electrical ground during ejection of the plasma 64. Therefore, the dielectric coating 78 may disrupt an electrical path between the plasma igniter 62, e.g., the firing tip 68, and the cylinder head 26 during ejection of the plasma 64. That is, the plurality of streamers 72 ejected from the firing tip 68 during an ignition event may not form an electrical arc 82 (FIG. 5) which contacts the cylinder head 26. Rather, the internal combustion engine 10 may be substantially free from the electrical arc 82 connecting the plasma igniter 62 and the cylinder head 26. Stated differently, the plurality of streamers 72 may not form the electrical arc 82, but rather the plasma 64 may be ejected from the firing tip 68 and continuously form the plurality of streamers 72 and/or branches 74 so that the fuel 22 is combusted efficiently and completely. That is, the plasma igniter 62 and the cylinder head 26 may not be connected by the electrical arc 82. In other words, the dielectric coating 78 may interrupt an electrical path between the cylinder head 26 and the plasma igniter 62 such that the plasma 64 does not transition into the electrical arc 82 upon contact with the cylinder head 26.

In another embodiment, the dielectric coating 78 is also disposed on the piston head 36, as indicated in FIGS. 3A and 3B. That is, the dielectric coating 78 is disposed on both the cylinder head 26 and the piston head 36 to further insulate the plasma 64 from a path to an electrical ground. Since the piston head 36 may be formed from a metal, e.g., a low carbon steel or an aluminum alloy, the plurality of streamers 72 and/or branches 74 of the plasma 64 may seek a path to an electrical ground after ejection from the firing tip 68 into the combustion chamber 32. The dielectric coating 78 disposed on the piston head 36 may disrupt such a path and prevent arcing of the plasma 64. As such, the internal combustion engine 10 may be substantially free from the electrical arc 82 (FIG. 5) connecting the plasma igniter 62 and the piston head 36. That is, the plasma igniter 62 and the piston head 36 may not be connected by the electrical arc 82.

Further, alternatively or additionally, the dielectric coating 78 may be disposed on the valve 58, 158. That is, the dielectric coating 78 may be disposed on the cylinder head 26, the piston head 36, and/or the valve 58, 158 to further insulate the plasma 64 from a path to an electrical ground. Since the valve 58, 158 may also be formed from a metal, e.g., a low carbon steel or an aluminum alloy, the plurality of streamers 72 and/or branches 74 of the plasma 64 may seek a path to an electrical ground after ejection from the firing tip 68 into the combustion chamber 32. The dielectric coating 78 disposed on the valve 58, 158 may disrupt such a path and prevent arcing of the plasma 64. As such, the internal combustion engine 10 may also be substantially free from the electrical arc 82 (FIG. 5) connecting the plasma igniter 62 and the valve 58, 158. That is, the plasma igniter 62 and the valve 58, 158 may not be connected by the electrical arc 82.

Alternatively or additionally, the dielectric coating 78 may be disposed on the plasma igniter 62, e.g. on the firing tip 68, so as to protect the plasma igniter 62 from wear and/or soot or residue build-up upon repeated firings. That is, the dielectric coating 78 may be disposed on the cylinder head 26, the piston head 36, the valve 58, 158, and/or the plasma igniter 62 to further insulate the plasma 64 from a path to an electrical ground.

Therefore, the plasma igniter 62 and the dielectric coating 78 enable efficient and effective combustion within the combustion chamber 32 during operation of the internal combustion engine 10. In particular, the dielectric coating 78 substantially prevents an electrical arc 82 (FIG. 5) from forming within the combustion chamber 32 of the internal combustion engine 10. As such, the internal combustion engine 10 may be especially suitable for operating during a lean combustion condition, i.e., when the fuel 22 is diluted by air and/or exhaust gases, and may be substantially free from misfire and unstable combustion.

Further, the dielectric coating 78 allows for precise placement and optimal protrusion of the plasma igniter 62 into the combustion chamber 32. That is, since the dielectric coating 78 is disposed on the cylinder head 26, the distance 76 that the plasma igniter 62 protrudes from the cylinder head 26 into the combustion chamber 32 may be comparatively small, e.g., from about 1 mm to about 5 mm. Alternatively, since the dielectric coating 78 may also be disposed on the piston head 36, the valve 58, 158, and/or the plasma igniter 62, the distance 76 that the plasma igniter 62 protrudes from the cylinder head 26 into the combustion chamber 32 may be comparatively large, e.g., from about 5 mm to about 15 mm. Therefore, an optimal protrusion depth of the plasma igniter 62 into the combustion chamber 32, i.e., the distance 76, may be selected according to desired combustion characteristics, e.g., the spray angle 54 of the fuel 22, particularly when the internal combustion engine 10 operates as a downsize boosted engine during a dilute combustion mode.

That is, the internal combustion engine 10 may include a reduced number of cylinder bores 28 and combustion chambers 32 and yet may still produce a required power for a given vehicle operating condition. Stated differently, the internal combustion engine 10 may provide sufficient power and similar performance of a larger engine, yet may be comparatively more efficient and produce relatively less emissions than the larger engine. Therefore, the vehicle 12 may be comparatively lightweight and fuel efficient.

Further, the plasma igniter 62 and dielectric coating 78 enable fuels 22 to be injected in a shape having a comparatively wider spray angle 54 within the combustion chamber 32. Such spray angles 54, e.g., from about 70° to about 120°, enable optimal distribution and efficient mixing of air and the fuel 22 within the combustion chamber 32 and therefore minimize misfire and/or inefficient combustion within the combustion chamber 32. Therefore, the internal combustion engine 10 exhibits excellent combustion stability and fuel efficiency and reduced emissions as compared to engines (not shown) which do not include the dielectric coating 78.

While the best modes for carrying out the disclosure have been described in detail, those familiar with the art to which this disclosure relates will recognize various alternative designs and embodiments for practicing the disclosure within the scope of the appended claims.

1. An internal combustion engine for a vehicle, the internal combustion engine comprising:
a cylinder block defining a combustion chamber therein;
a cylinder head mated to the cylinder block such that the cylinder head covers the combustion chamber;
a fuel nozzle configured for injecting a fuel into the combustion chamber;
a plasma igniter configured for ejecting a plasma into the combustion chamber to ignite the fuel, wherein the plasma igniter extends through the cylinder head and protrudes into the combustion chamber; and
a dielectric coating disposed on the cylinder head.

2. The internal combustion engine of claim 1, wherein the dielectric coating has a thickness of from about 0.05 mm to about 5 mm.

3. The internal combustion engine of claim 1, wherein the cylinder head includes a portion facing the combustion chamber, and further wherein the dielectric coating is a ceramic and coats the portion.

4. The internal combustion engine of claim 1, wherein the dielectric coating is heat-resistant at a temperature of less than or equal to about 1,100° C.

5. The internal combustion engine of claim 4, wherein the dielectric coating is an alumina.

6. The internal combustion engine of claim 1, wherein the internal combustion engine is substantially free from an electrical arc connecting the plasma igniter and the cylinder head.

7. The internal combustion engine of claim 1, wherein the plasma igniter has a firing tip spaced apart from the cylinder head by a distance of from about 1 mm to about 15 mm.

8. The internal combustion engine of claim 7, wherein the fuel has a first boundary and a second boundary defining a spray angle therebetween.

9. The internal combustion engine of claim 8, wherein the firing tip protrudes into the combustion chamber at the distance of from about 5 mm to about 15 mm and the spray angle is from about 50° to about 70 °.

10. The internal combustion engine of claim 8, wherein the firing tip protrudes into the combustion chamber at the distance of from about 1 mm to about 5 mm and the spray angle is from about 70° to about 120 °.

11. The internal combustion engine of claim 7, wherein the plasma includes a plurality of streamers each extending from the firing tip and configured for igniting the fuel within the combustion chamber.

12. The internal combustion engine of claim 1, wherein the dielectric coating is disposed on the plasma igniter.

13. The internal combustion engine of claim 1, wherein the cylinder head defines a port therein, and further including a valve configured for alternatingly allowing and preventing fluid communication between the port and the combustion chamber.

14. The internal combustion engine of claim 13, wherein the dielectric coating is disposed on the valve.

15. An internal combustion engine for a vehicle, the internal combustion engine comprising:
a cylinder block defining a combustion chamber therein;
a cylinder head mated to the cylinder block such that the cylinder head covers the combustion chamber;
a fuel nozzle configured for injecting a fuel into the combustion chamber;
a plasma igniter configured for ejecting a plasma into the combustion chamber to ignite the fuel, wherein the plasma igniter extends through the cylinder head and protrudes into the combustion chamber;
a piston head disposed within the combustion chamber and alternatingly translatable towards and away from the cylinder head; and
a dielectric coating disposed on the cylinder head and the piston head.

16. The internal combustion engine of claim 15, wherein the internal combustion engine is substantially free from an electrical arc connecting the plasma igniter and the piston head.

17. The internal combustion engine of claim 16, wherein the cylinder head defines a port therein and the dielectric coating is disposed on the cylinder head within the port, and further including a valve configured for alternatingly allowing and preventing fluid communication between the port and the combustion chamber.

18. The internal combustion engine of claim 17, wherein the dielectric coating is disposed on the valve.

19. The internal combustion engine of claim 18, wherein the internal combustion engine is substantially free from an electrical arc connecting the plasma igniter and the valve.

20. A vehicle comprising:
a plurality of wheels each rotatable to translate the vehicle along a surface; and
an internal combustion engine operably connected to the plurality of wheels and including:
a cylinder block defining a combustion chamber therein;
a cylinder head mated to the cylinder block such that the cylinder head covers the combustion chamber;
a fuel nozzle configured for injecting a fuel into the combustion chamber;
a plasma igniter configured for ejecting a plasma into the combustion chamber to ignite the fuel, wherein the plasma igniter extends through the cylinder head and protrudes into the combustion chamber; and
a dielectric coating disposed on the cylinder head.
